(19) United States
(12) Patent Application Publication
(10) Pub. No.: US 2006/0182444 A1
(43) Pub. Date: Aug. 17, 2006

(54) Controlling proportional allocation transmission in an EPON through an OLT scheduling algorithm

(75) Inventors: Sang-Hyun Doh, Hwaseong-gun (KR); Tae-Sung Park, Yongin-si (KR); Seong-Ha Kim, Yongin-si (KR)

Correspondence Address: CHA & REITER, LLC, 210 ROUTE 4 EAST STE 103, PARAMUS, NJ, 07652, US

(73) Assignee: Samsung Electronics Co., Ltd

(21) Appl. No.: 11/355,332

(22) Filed: Feb. 16, 2006

(30) Foreign Application Priority Data
Feb. 16, 2005 (KR) 2005-12816

(51) Int. Cl. H04J 14/00

(52) U.S. Cl. 398/69

(57) ABSTRACT

Disclosed is a method, apparatus and computer product for controlling proportional allocation transmission through an OLT scheduling algorithm in an EPON based FTTH system. The method includes computing a total transmission capacity for Optical Network Terminations (ONTs) connected to the OLT, computing a number of transmissions according to the ONTs, storing the computed number of transmissions according to the ONTs in a storage unit, determining a transmission order for each ONT based on the number of transmissions according to the ONTs, and transmitting data according to the determined transmission order.

CLAIM of PRIORITY

This application claims the benefit of the earlier filing date of that patent application entitled “Method For Controlling Proportional Allocation Transmission Through OLT Scheduling Algorithm,” filed in the Korean Intellectual Property Office on Feb. 16, 2005, and assigned Serial No. 2005-12816, the contents of which are hereby incorporated by reference.

### BACKGROUND OF THE INVENTION

1. Field of the Invention

The present invention relates generally to an Ethernet Passive Optical Network (EPON), and more specifically to a proportional allocation transmission method in an EPON based on a Fiber To The Home (FTTH) network configuration for providing a differential service to each subscriber.

2. Description of the Related Art

A Passive Optical Network (PON) is a subscriber network for forming a distributed topology with a tree structure, in which one Optical Line Termination (OLT) is connected to a plurality of Optical Network Units (ONUs) through a 1×N Optical Distribution Network (ODN). Such a PON may be classified as ATM-PON, EPON, or WDM-PON according to construction schemes and the protocols used in communicating over the network.

The EPON is receiving the most visibility and interest as a large capacity of subscriber network, which provides a differential service to each subscriber. A method has been proposed which directly performs a rate limiting function for data rates according to subscribers through subscriber ports.

A conventional PON for providing a differential service as described above will now be described. Generally, in order to improve the operation efficiency of a PON and provide a good quality of service, each Internet Service Provider (ISP) differentiates subscribers and allocates different traffic transmission capacities to subscribers. Further, each ISP inserts a data rate limitation function for limiting the transmission of data traffic exceeding a predetermined amount for each subscriber interface unit.

An existing data rate limitation function performed by an EPON for a Fiber-To-The-Home (FTTH) service uses a method for directly assigning a predetermined allocated amount to Optical Network Termination (ONT) ports of each subscriber.

FIG. 1 is a block diagram illustrating the construction of an EPON for providing an FTTH service according to the prior art.

Referring to FIG. 1, the EPON for providing the FTTH service according to the prior art includes an OLT 11 for connection with an upper-stream network (not shown), an ODN 12, which is a passive apparatus, for optically distributing data from the OLT 11 in a 1×N fashion, and ONTs 13-1 to 13-3 which are allocated to each subscriber and operate as subscriber interface units.

A conventional data rate limitation function, as described above, assigns data rates of 20 Mbps, 40 Mbps and 60 Mbps to the ONT ports 13-1 to 13-3, and provided to each subscriber, respectively, and limits the transmission of data exceeding the assigned data rate, thereby limiting a data rate in the EPON of FIG. 1.

Such a conventional scheme does not cause any problems when it operates in an ideal environment, but the following problems occur when it is actually used.

First, there may occur a case in which the limitation of the data rates assigned to each subscriber does not have actual meaning.

For example, the EPON aims at providing transmission capacity of about 100 Mbps per household on the basis of an FTTH service. However, as illustrated in FIG. 1, since the EPON has a structure in which the ONTs 13-1 to 13-3 are connected to one OLT 11, the actual data rate which may be provided to each household does not reach 100 Mbps. Generally, the OLT trunk capacity of an EPON is 1 gigbyte and one OLT 11 accommodates 32 or 64 ONTs. Therefore, in the worst case, a data rate of at most 15 Mbps may be ensured for each household and only this level of data rate is actually insured. This is the worst case (i.e., all ONTs access to OLT and receive data), and it is common that in the design of the FTTH service the number of ONTs, etc., is determined with consideration of a simultaneous access rate according to households.

Although the simultaneous access rate is considered, the number of ONTs allocated can exceed the trunk transmission capacity when considering the economical efficiency of the EPON, etc. When more than a predetermined number of subscribers use a service, the subscribers must unavoidably share a data rate.

If a data rate limitation value is statically determined as in the existing data rate limitation function, it may be impossible to actually limit the data rate. That is, when it is assumed that there are three grades of service (i.e., 1, 2 and 3), a data rate limitation value among three grades may be set to a relatively high value. Herein, in a case in which more than a predetermined number of ONTs have access to one OLT, there is no differential effect among three grades. That is, if each ONT shares transmission capacity and obtains capacity of about only 60 Mbps, differentiation in more than 60 Mbps does not have any effect. Therefore, three grades classified in more than 60 Mbps do not have any real meaning.

In the meantime, if a data rate limitation value is determined to have a relatively small value (e.g. below 30 Mbps), this departs from the target of providing the transmission capacity of 100 Mbps to each household. Further, even when network situations are bad (when transmission capacity must be shared) or network conditions are good, overall satisfaction for a service may be reduced because the transmission capacity is not large.

### SUMMARY OF THE INVENTION

Accordingly, the present invention has been made to solve the above-mentioned problems occurring in the prior art and provides additional advantages, by providing a method of controlling proportional allocation transmission through an OLT scheduling algorithm, which sets a relative rate for each subscriber instead of setting a data rate limitation function in an EPON to a fixed value, thereby effectively managing a differential transmission service.

According to one aspect of the present invention, there is provided a method for controlling proportional allocation transmission through an Optical Line Termination (OLT) scheduling algorithm in a Fiber-To-The-Home (FTTH) system based on an Ethernet Passive Optical Network (EPON). The method includes computing a total transmission capacity for Optical Network Terminations (ONTs) connected to the OLT; computing a number of transmissions according to the ONTs, storing the computed number of transmissions according to the ONTs in a storage unit, determining a transmission order for each ONT based on the number of transmissions according to the ONTs, and transmitting data according to the determined transmission order.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating the construction of an EPON for providing an FTTH service according to the prior art;

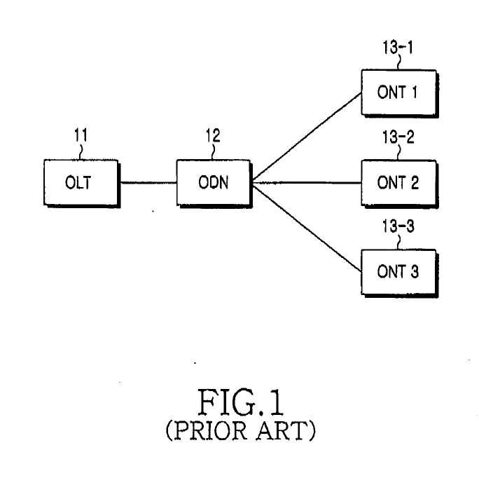

FIG. 2 is a block diagram illustrating the construction of an EPON for providing an FTTH service, to which a method for controlling proportional allocation transmission through an OLT scheduling algorithm is applied, according to one embodiment of the present invention;

FIG. 3 is a flow diagram illustrating a method for controlling proportional allocation transmission through an OLT scheduling algorithm according to one embodiment of the present invention; and

FIG. 4 is a flow diagram illustrating in detail a process for determining an ONT transmission order shown in FIG. 3.

### DETAILED DESCRIPTION

An embodiment of the present invention is described in detail herein with reference to the accompanying drawings. The same reference numerals are used to designate the same elements as those shown in each of the drawings. For the purposes of clarity and simplicity, a description of well known functions and configurations incorporated herein will be omitted as it may obscure the subject matter of the present invention.

A general data transmission system uses a point-to-point scheme, but an Ethernet Passive Optical Network (EPON) uses a point-to-multi point scheme by its structural characteristics, as described above.

Downlink transmission from an Optical Line Termination 11 (OLT) to an Optical Network Termination (ONT) 13-1, for example, in an EPON is relatively free. However, in the uplink transmission from the ONT 13-1 to the OLT 11, collision among the data transmitted occurs. Therefore, the OLT controls and schedules transmission time and scheme of each of the ONTs.

More specifically, the OLT 11 determines the transmission time, etc., of each ONT 13-1 . . . 13-3, by communicating with the ONTs, and each ONT transmits data during a corresponding time so that it is possible to avoid collision among data transmitted from ONTs.

The scheduling and control between the OLT 11 and the ONTs 13-1 . . . 13-3 is performed by a scheme for dynamically assigning a transmission band in consideration of length of data, transmission capacity, etc., or a scheme for distributing a predetermine time to each ONT and statically assigning a transmission band by the distributed time.

A method proposed by the present invention can be applied to all schemes for dynamically or statically assigning a transmission band. In one aspect of the present invention, for convenience of description, a fixed band assignment scheme for assigning a transmission band during a predetermine time period is now described.

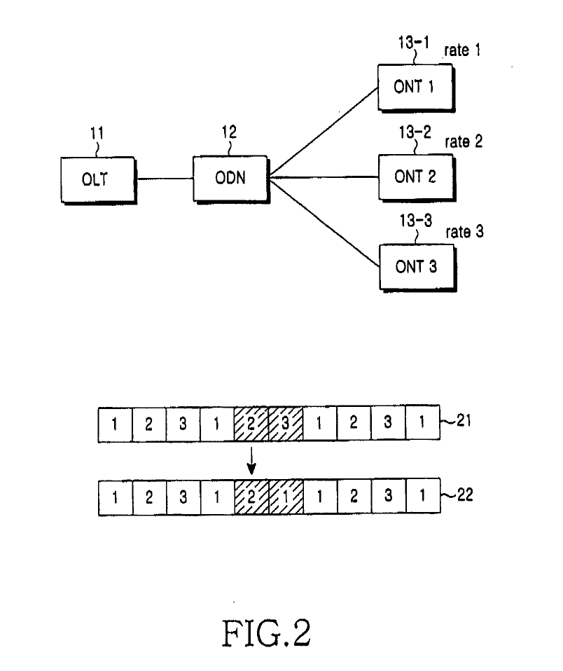

FIG. 2 is a block diagram illustrating the construction of an EPON for providing an FTTH service, to which a method for controlling proportional allocation transmission through an OLT scheduling algorithm is applied, according to one embodiment of the present invention.

Referring to FIG. 2, the EPON for providing the FTTH service according to the present invention includes an OLT 11 for connection with an upper-stream network, an Optical Distribution Network (ODN) 12, which is typically a passive apparatus, for optically distributing data from the OLT 11 in a 1×N fashion, and ONTs 13-1 to 13-3 which are allocated to each subscriber and operate as subscriber interface units.

The ONTs 13-1 to 13-3 have data rates, in this illustrative example, of rate 1, rate 2 and rate 3, respectively.

As an example, the conventional data rate limitation may be fixed data rates of 60 Mbps, 40 Mbps, 20 Mbps, which are assigned to the ONTs 13-1 to 13-3 respectively and classified into rate 1, 2 and 3 grades. In this illustrative example, a data rate is limited to within the respective predetermined data rate. However, in the embodiment of the present invention, a data rate limitation function is managed at a relative rate.

That is, if it is assumed that each ONT has the same fixed data rate, data transmission is performed as shown in a time-slot allocation shown as reference number 21. In other words, for the ONT 13-1, the ONT 13-2 and the ONT 13-3, data transmission is sequentially performed in a sequence of 1-2-3-1-2-3-1-2-3-1, etc.

In a case of applying the relative rate to the ONTs, the ONT 13-1 having a first grade rate is set to have one-additional data transmission opportunity as compared with a reference standard grade (e.g. second grade), in number of transmissions. Further, the ONT 13-3 having a third grade of rate is set to have one fewer data transmission opportunity as compared with the reference standard grade (e.g. second grade), in number of transmissions. If it is assumed that each ONT has different data rates according to grades, data transmission is performed in the time-slot allocation shown as reference number 22. That is, for the ONT 13-1, the ONT 13-2 and the ONT 13-3, data transmission is sequentially performed in a sequence of 1-2-3-1-2-1-1-2-3-1 . . . .

The embodiment of the present invention includes the following basic concept. As described above, the EPON needs scheduling of an OLT-side for data transmission of an ONT-side due to the characteristics of the point-to-multi point. Herein, in the embodiment of the present invention, the scheduling structurally performed by an OLT is controlled, so that transmission capacities of each ONT are limited. For example, it is assumed that an EPON includes one OLT and four ONTs connected to the OLT. Transmission authority is sequentially assigned to the first ONT to the fourth ONT according to the rate, so that transmission capacity of the ONT is differentially assigned.

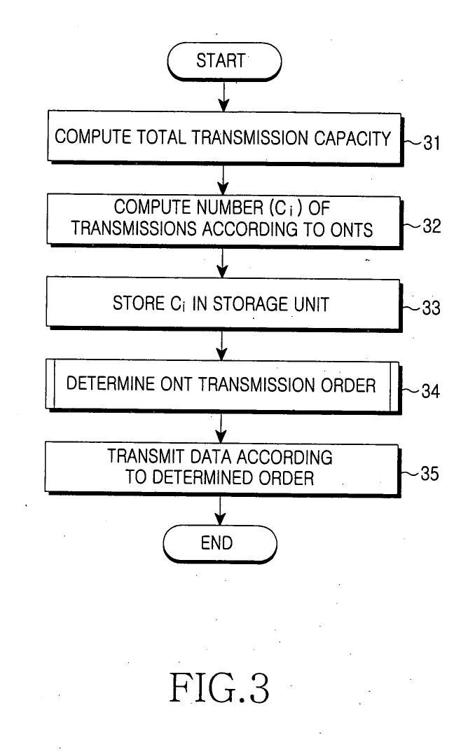

FIG. 3 is a flow diagram illustrating a method for controlling proportional allocation transmission through an OLT scheduling algorithm according to one embodiment of the present invention.

Referring to FIG. 3, the total transmission capacity (K₀) for each ONT is computed at block 31. The total transmission capacity represents a value obtained by summing up transmission capacity ratios assigned to all ONTs in an EPON. This may be determined as:
K₀=K₁+K₂+ . . . +Kᵢ).

Further, the ONTs have different transmission capacity according to the grades of services which the ONTs have used.

Further, a number (Cᵢ) of transmissions according to the each of the i^{th} ONT is computed at block 32. The number (Cᵢ) of transmissions according to the i^{th} ONT represents a value (e.g. K₀/Kᵢ) obtained by dividing the total transmission capacity by a transmission capacity assigned to a corresponding i^{th} ONT.

The number of transmissions according to the ONTs is stored in a storage unit (33).

An ONT transmission order is determined at block 34 and data are transmitted according to the determined transmission order at block 35.

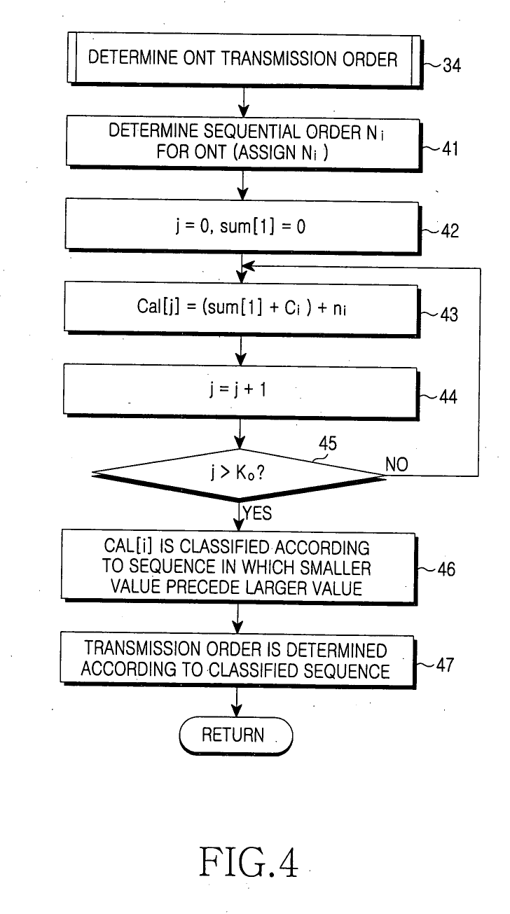

FIG. 4 is a flow diagram illustrating in detail a process for determining the ONT transmission order according to the present invention.

Referring to FIG. 4, a sequential order (nᵢ) for each of the i^{th} ONTs is determined at block 41. The sequential order for each i^{th} ONT is a registered order, which may be determined according to an ONT ID.

An initial variable is set (i.e., j=0, sum[i]=0) at block 42 and transmission order values (Cal[i]) are computed at block 43.

The transmission order values may be computed by equation 1 as:
Cal[i]=(sum[i]+Cᵢ)+nᵢ [1]

In equation 1, the Cᵢ represents the number of transmissions according to the ONTs and the nᵢ represents the sequential order for each ONT.

The transmission order values are repeated until the total transmission capacity is determined at blocks 44 and 45, and the computed transmission order values are classified according to a sequence in which a smaller value precedes a larger value at block 46. Then, the transmission order is determined according to the classified sequence at block 47.

The conventional data rate limitation has the following problems. The FTTH system for providing 100 Mbps at maximum to each subscriber may have a distorted meaning or the entire quality of a service may deteriorate. Further, when it is assumed that one OLT and 32 ONTs and thus network conditions become worse due to access by all ONTs, limiting a data rate to at least 32 Mbps is meaningless. In addition, in a case in which a data rate is set below 32 Mbps and the data rate limitation becomes meaningful, when network conditions become worse, transmission of more than 32 Mbps is impossible. Therefore, the entire quality of a service deteriorates. These problems are overcome by limiting a relative data rate through the process as described above, so that it is possible to insure relative traffic among subscribers. That is, since some of 32 subscribers receive relative data rates of 20%, 16%, 32%, 100%, etc., as compared with other subscribers, they always receive a relative differential service due to the variability of network conditions, a simultaneous access rate, etc. Further, even when network conditions are good or bad, it is possible to always provide a differential service.

As described above, in assigning the same range of transmission authority to each ONT, a corresponding number of transmissions is differently employed, so that a differential service is provided. However, this is only an example for a relative differentiation of a service and the present invention is not limited to this example.

That is, different ranges of transmission authority may be assigned to each ONT, so that it is possible to accomplish the object of the present invention. In this case, time intervals relating to transmission authority are differentiated, so that proportional allocation transmission control according to the present invention can be performed.

The present invention as described above solves the problems of an existing data rate limitation function in an EPON, i.e. if a predetermined value is assigned to each ONT, a data rate limitation may have reduced effect or may be meaningless according to the number of ONTs connected to an OLT and a network simultaneous access rate, thereby relatively ensuring the service quality desired by each subscriber.

The above-described method according to the present invention can be realized as software and can be stored in a recording medium such as a CD ROM, a RAM, a floppy disk, a hard disk and a magneto-optical disk or downloaded over a network, so that a user can read such software by using a computer.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method, operable in a computer system, for controlling proportional allocation transmission through an Optical Line Termination (OLT) scheduling algorithm in a Fiber-To-The-Home (FTTH) system based on an Ethernet Passive Optical Network (EPON), the method comprising the steps of:
computing a total transmission capacity for Optical Network Terminations (ONTs) connected to the OLT;
computing a number Cᵢ of transmissions according to the ONTs;
storing the computed number of transmissions according to the ONTs in a storage unit;
determining a transmission order for each ONT based on the number of transmissions according to the ONTs; and
transmitting data according to the determined transmission order.

2. The method as claimed in claim 1, wherein the step of determining a transmission order further comprises the steps of:
determining a sequential order nᵢ for each ONT;
computing transmission order values Cal[i] for each ONT based on the number of transmissions according to the ONTs within the total transmission capacity; and
arranging the computed transmission order values Cal[i] for each ONT according to a sequence in which a larger transmission order value precedes a smaller transmission order value, thereby determining the transmission order for each ONT.

3. The method as claimed in claim 2, wherein the transmission order values Cal[i] are computed as,
Cal[i]=(sum[i]+Cᵢ)+nᵢ
wherein Cᵢ represents the number of transmissions according to the ONTs and nᵢ represents the sequential order for each ONT.

4. The method as claimed in claim 2, wherein the sequential order for each ONT is determined according to a sequence in which each ONT has been registered.

5. The method as claimed in claim 2, wherein the sequential order for each ONT is determined according an ONT ID of each ONT.

6. The method as claimed in claim 1, wherein the total transmission capacity represents a value obtained by summing up all transmission capacity assigned to all ONTs connected to the OLT.

7. The method as claimed in claim 6, wherein the transmission capacity assigned to each ONT has different values according to grades of services which the ONTs have used.

8. The method as claimed in claim 7, wherein the transmission capacity assigned to each ONT has different values according to the grades of the services which the ONTs have used, so that a number of transmissions by which the OLT transmits data to each ONT is differently determined.

9. A computer program product including computer code for controlling proportional allocation transmission through an Optical Line Termination (OLT) scheduling algorithm in a Fiber-To-The-Home (FTTH) system based on an Ethernet Passive Optical Network (EPON), the computer code providing instruction to a computer system for executing the steps of:
computing a total transmission capacity for Optical Network Terminations (ONTs) connected to the OLT;
computing a number Cᵢ of transmissions according to the ONTs;
storing the computed number of transmissions according to the ONTs in a storage unit;
determining a transmission order for each ONT based on the number of transmissions according to the ONTs; and
transmitting data according to the determined transmission order.

10. The computer program product as claimed in claim 9, wherein the step of determining a transmission order further comprises the computer code providing instruction to the computer system for executing the steps of:
determining a sequential order nᵢ for each ONT;
computing transmission order values Cal[i] for each ONT based on the number of transmissions according to the ONTs within the total transmission capacity; and
arranging the computed transmission order values Cal[i] for each ONT according to a sequence in which a larger transmission order value precedes a smaller transmission order value, thereby determining the transmission order for each ONT.

11. The computer program product as claimed in claim 10, wherein the transmission order values Cal[i] are computed as,
Cal[i]=(sum[i]+Cᵢ)+nᵢ
wherein Cᵢ represents the number of transmissions according to the ONTs and nᵢ represents the sequential order for each ONT.

12. The computer program product as claimed in claim 10, wherein the sequential order for each ONT is determined according to a sequence in which each ONT has been registered.

13. The computer program product as claimed in claim 10, wherein the sequential order for each ONT is determined according to an ONT ID of each ONT.

14. The computer program product as claimed in claim 9, wherein the total transmission capacity represents a value obtained by summing up all transmission capacity assigned to all ONTs connected to the OLT.

15. The computer program product as claimed in claim 14, wherein the transmission capacity assigned to each ONT has different values according to grades of services which the ONTs have used.

16. The computer program product as claimed in claim 15, wherein the transmission capacity assigned to each ONT has different values according to the grades of the services which the ONTs have used, so that a number of transmissions by which the OLT transmits data to each ONT is differently determined.

17. An apparatus for controlling proportional allocation transmission through an Optical Line Termination (OLT) scheduling algorithm in a Fiber-To-The-Home (FTTH) system based on an Ethernet Passive Optical Network (EPON), the apparatus comprising:
a processor in communication with a memory, the processor executing computer code for executing the steps of:
computing a total transmission capacity for Optical Network Terminations (ONTs) connected to the OLT;
computing a number Cᵢ of transmissions according to the ONTs;
storing the computed number of transmissions according to the ONTs in a storage unit; and
determining a transmission order for each ONT based on the number of transmissions according to the ONTs, and
transmitting data according to the determined transmission order.

18. The apparatus as claimed in claim 17, wherein the step of determining a transmission order further comprises the processor executing code for executing the steps of:
determining a sequential order nᵢ for each ONT;
computing transmission order values Cal[i] for each ONT based on the number of transmissions according to the ONTs within the total transmission capacity; and
arranging the computed transmission order values Cal[i] for each ONT according to a sequence in which a larger transmission order value precedes a smaller transmission order value, thereby determining the transmission order for each ONT.

19. The apparatus as claimed in claim 18, wherein the transmission order values Cal[i] are computed as,
Cal[i]=(sum[i]+Cᵢ)+nᵢ
wherein Cᵢ represents the number of transmissions according to the ONTs and nᵢ represents the sequential order for each ONT.

20. The apparatus as claimed in claim 18, wherein the sequential order for each ONT is determined according to a sequence in which each ONT has been registered.

21. The apparatus as claimed in claim 18, wherein the sequential order for each ONT is determined according to ONT IDs of each ONT.

22. The apparatus as claimed in claim 17, wherein the total transmission capacity represents a value obtained by summing up all transmission capacity assigned to all ONTs connected to the OLT.

23. The apparatus as claimed in claim 22, wherein the transmission capacity assigned to each ONT has different values according to grades of services which the ONTs have used.

24. The apparatus as claimed in claim 22, wherein the transmission capacity assigned to each ONT has different values according to the grades of the services which the ONTs have used, so that a number of transmissions by which the OLT transmits data to each ONT is differently determined.
